(19) United States
(12) Patent Application Publication
(10) Pub. No.: US 2011/0013341 A1
(43) Pub. Date: Jan. 20, 2011

(54) MULTILAYER CHIP CAPACITOR

(75) Inventors: Min Cheol PARK, Gwangmyeong (KR); Dong Seok Park, Seoul (KR); Byoung Hwa Lee, Seongnam (KR); Young Ghyu Ahn, Yongin (KR); Sang Soo Park, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/651,175

(22) Filed: Dec. 31, 2009

(30) Foreign Application Priority Data
Jul. 17, 2009 (KR) 10-2009-0065492

(51) Int. Cl. H01G 4/06; H01G 4/30

(52) U.S. Cl. 361/313

(57) ABSTRACT

Disclosed is a multilayer chip capacitor including a capacitor body including a plurality of dielectric layers that are stacked, first and second outer electrodes of opposite polarity disposed on an outer face of the capacitor body, first and second inner electrodes opposing each other inside the capacitor body to interpose the dielectric layer therebetween, the first inner electrode comprising an electrode plate forming capacitance and a lead extending from the electrode plate and connected to the first outer electrode, and the second inner electrode comprising an electrode plate forming capacitance and a lead extending from the electrode plate and connected to the second outer electrode. The leads are bent at least once and each have an overlap portion overlapping a lead of an adjacent inner electrode of opposite or like polarity when viewed along a stacked direction in which the plurality of dielectric layers are stacked.

### CROSS-REFERENCE TO RELATED APPLICATIONS

This application claims the priority of Korean Patent Application No. 10-2009-0065492 filed on Jul. 17, 2009, in the Korean Intellectual Property Office, the disclosure of which is incorporated herein by reference.

### BACKGROUND OF THE INVENTION

1. Field of the Invention

The present invention relates to a multilayer chip capacitor, and more particularly, to a multilayer chip capacitor capable of attaining a significant increase in equivalent series resistance (ESR) while maintaining equivalent series inductance (ESL) at a low level.

2. Description of the Related Art

A power distribution network (PDN) of a micro processor unit (MPU) is increasingly difficult to design due to the higher speeds and greater integration of MPU. Notably, a decrease in power voltage and an increase in MPU consumption current resulting from greater integration of the MPU has been gradually lowering a target impedance Z_{target} as represented by the following Equation 1:

Z_{target}=Vp×AR/I=Vr/I Equation 1,

where Vp is a power voltage, AR is an allowed ripple, I is an MPU consumption current, and a Vr is an allowed ripple voltage.

A general ripple voltage Vr ranges from approximately 5% to 10% of the power voltage. The target impedance Z_{target} should be satisfied not only in a direct current (DC) but also in all frequencies where a transient current is present. A personal computer (PC) or a laptop computer undergoes a transient current even in a very high frequency range due to higher speed of a central processing unit (CPU), that is, an MPU chip, and thus should satisfy a target impedance even in a broad frequency range.

A multilayer chip capacitor (MLCC) is used in a power distribution network as a decoupling capacitor. This multilayer chip capacitor supplies a current to a central processing unit (CPU) to suppress voltage noise when a load current suddenly changes. In order to suppress noise sufficiently at high frequencies, a decoupling capacitor is required to have lower equivalent series inductance (hereinafter, ‘ESL’) while ensuring sufficiently high equivalent series resistance (hereinafter, ‘ESR’) to thereby achieve stability. However, a reduction in ESL generally leads to a decrease in ESR, and this makes it difficult to increase ESR while keeping ESL at a low level in a multilayer chip capacitor.

### SUMMARY OF THE INVENTION

An aspect of the present invention provides a multilayer chip capacitor having improved performance in suppressing voltage noise, generated due to a sudden change in load current, by increasing ESR significantly while maintaining ESL at a low level.

According to an aspect of the present invention, there is provided a multilayer chip capacitor including: a capacitor body including a plurality of dielectric layers that are stacked; first and second outer electrodes of opposite polarity, disposed on an outer face of the capacitor body; first and second inner electrodes opposing each other inside the capacitor body to interpose the dielectric layer therebetween, the first inner electrode including an electrode plate forming capacitance and a lead extending from the electrode plate and connected to the first outer electrode, and the second inner electrode including an electrode plate forming capacitance and a lead extending from the electrode plate and connected to the second outer electrode, wherein the leads of the first and second inner electrodes are bent at least once and each have an overlap portion overlapping a lead of an inner electrode of opposite or like polarity disposed adjacent to a corresponding one of the first and second inner electrodes when viewed along a stacked direction in which the plurality of dielectric layers are stacked.

The electrode plates may have a rectangular shape when viewed in the stacked direction, and the leads may each have a portion parallel to one side of the rectangular shape.

The overlap portion may be included in the portion parallel to one side of the rectangular shape.

The leads may have a width ranging from 20 μm to 60 μm.

The multilayer chip capacitor may further include a connection portion disposed at a connection area between each of the leads and a corresponding one of the first and second outer electrodes, the connection portion having a wider width than the lead.

The first and second outer electrodes may include a plurality of first and second outer electrodes alternately disposed on one and opposite faces of the capacitor body.

The first and second outer electrodes may include four first and second outer electrodes disposed on each of one and opposite faces of the capacitor body.

The second outer electrodes may oppose the respective first outer electrodes.

The first and second outer electrodes, respectively connected to the leads of the first and second inner electrodes being adjacent to each other in the stacked direction, may be disposed adjacent to each other.

The first and second inner electrodes may each include a lead extending to each of one and opposite faces of the capacitor body. In this case, the leads of the first and second inner electrodes may be arranged in sequence from one edge to the other edge of the capacitor body and then back from the other edge to the one edge, sequentially in an upward direction of the stacked direction.

The first and second inner electrodes may be provided in three pairs so that six inner electrodes constitute a block, and the block is repetitively stacked.

The first and second inner electrodes may each include one lead extending to one face of the capacitor body. In this case, In this case, the leads of the first and second inner electrodes may be arranged in sequence from one edge to the other edge of the capacitor body and then back from the other edge to the one edge, sequentially in an upward direction of the stacked direction.

The first and second inner electrodes may be provided in four pairs so that eight inner electrodes constitute a block, and the block is repetitively stacked.

The first and second inner electrodes may each include two leads extending to each of one and opposite faces of the capacitor body.

The capacitor body may have a rectangular parallelepiped shape, and the first and second outer electrodes may be formed on a first side face of the capacitor body and a second side face thereof opposite to the first side face, respectively.

The electrode plates of the first and second inner electrodes may each have a rectangular shape when viewed in the stacked direction, the lead of the first inner electrode may extend from a side of the electrode plate perpendicular to the first and second first side faces, and the lead of the second inner electrode may extend from a side of the electrode plate perpendicular to the first and second side faces.

The electrode plates of the first and second inner electrodes may each have a rectangular shape when viewed in the stacked direction, the lead of the first inner electrode may extend from a side of the electrode plate opposing the first side face, and the lead of the second inner electrode may extend from a side of the electrode plate opposing the second side face.

In this case, the first and second inner electrodes may each have a portion overlapping a lead of an inner electrode of like polarity disposed adjacent to a corresponding one of the first and second inner electrodes when viewed in the stacked direction. A portion of the lead of the first inner electrode, connected to the first outer electrode perpendicularly to the first side face, may have a wider width than a portion of the lead of the first inner electrode being parallel to the first side face. A portion of the lead of the second inner electrode, connected to the second outer electrode perpendicularly to the second side face, may have a wider width than a portion of the lead of the second inner electrode being parallel to the second side face.

According to another aspect of the present invention, there is provided a multilayer chip capacitor including: a capacitor body including a plurality of dielectric layers that are stacked; first and second outer electrodes of opposite polarity, disposed on an outer face of the capacitor body; and first and second inner electrodes opposing each other inside the capacitor body to interpose the dielectric layer therebetween, the first inner electrode including an electrode plate forming capacitance and a lead extending from the electrode plate and connected to the first outer electrode, and the second inner electrode including an electrode plate forming capacitance and a lead extending from the electrode plate and connected to the second outer electrode, wherein the leads are bent at least once, the lead of the first inner electrode is connected to the first outer electrode and extends from a location of the electrode plate corresponding to the second outer electrode or a location thereof spaced further apart from the first inner electrode than the location corresponding to the second outer electrode, and the lead of the second inner electrode is connected to the second outer electrode and extends from a location of the electrode plate corresponding to the first outer electrode or a location thereof spaced further apart from the second inner electrode than the location corresponding to the first outer electrode.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating the exterior of a multilayer chip capacitor according to an exemplary embodiment of the present invention;

FIGS. 2 and 3 are schematic plan views for explaining the configuration of inner electrodes provided in the multilayer chip capacitor depicted in FIG. 1;

FIGS. 4 and 5 schematically illustrate current paths when the multilayer chip capacitor of FIG. 1 operates with a low frequency current and high frequency current, respectively;

FIGS. 6 through 8 are plan views schematically illustrating the configuration of inner electrodes applicable to the multilayer chip capacitor of FIG. 1;

FIG. 9 is an impedance graph for performance comparison between multilayer chip capacitors according to the present invention and the related art;

FIG. 10 is a schematic perspective view illustrating a multilayer chip capacitor according to another exemplary embodiment of the present invention;

FIGS. 11 and 12 are plan views for explaining the configuration of inner electrodes provided in the multilayer chip capacitor depicted in FIG. 10;

FIG. 13 schematically illustrates a current path when the multilayer chip capacitor of FIG. 12 operates with high frequency current; and

FIG. 14 is an impedance graph for performance comparison between multilayer chip capacitors according to the present invention and the related art.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity. Like reference numerals in the drawings denote like elements.

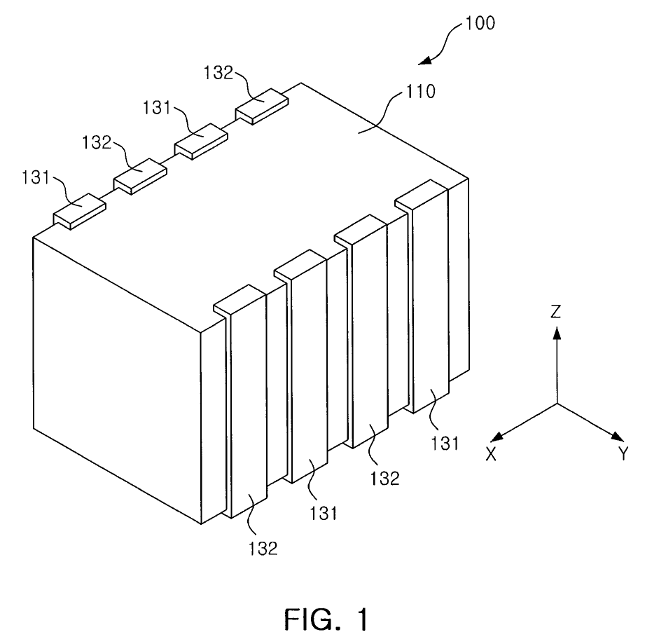

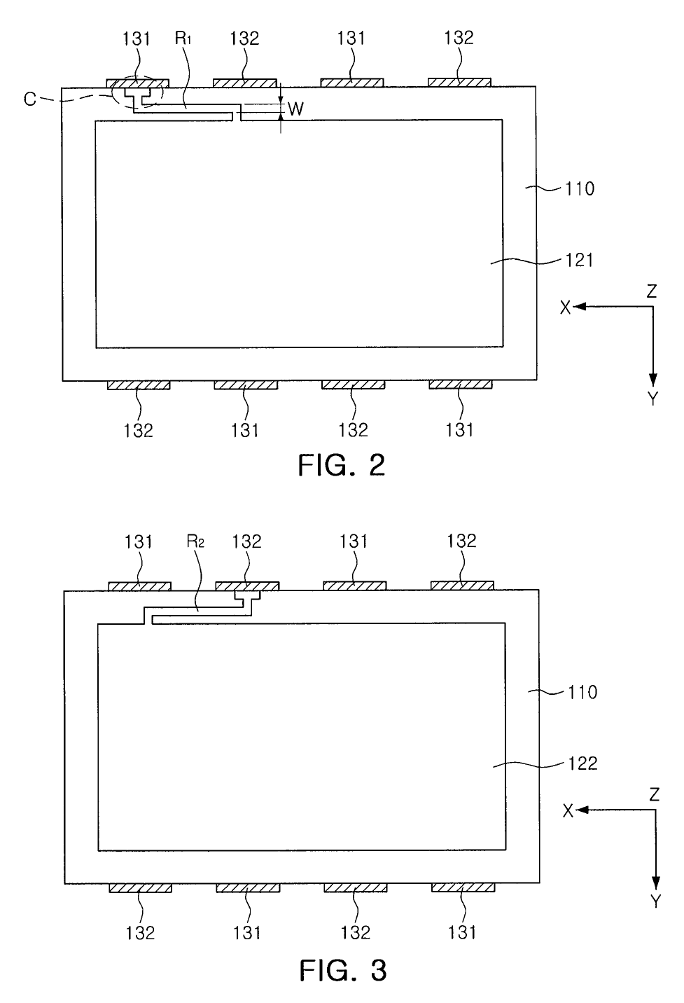

FIG. 1 is a schematic perspective view illustrating the exterior of a multilayer chip capacitor according to an exemplary embodiment of the present invention, and FIGS. 2 and 3 are schematic plan views for explaining the shape of inner electrodes provided in the multilayer chip capacitor of FIG. 1.

Referring to FIG. 1, a multilayer chip capacitor 100, according to this embodiment, includes a capacitor body 110 and a plurality of outer electrodes 131 and 132 (hereinafter, referred to as ‘first and second outer electrodes’ respectively) disposed on side faces of the capacitor body 110. The capacitor body 110 is formed by stacking a plurality of dielectric layers, and may have a rectangular parallelepiped shape or another similar shape. As shown in FIG. 1, the first and second outer electrodes 131 and 132 of opposite polarity may be disposed alternately on a first side face and an second side face opposite to the first side face of the capacitor body 110. In this case, although not limited thereto, the first outer electrodes 131 may oppose the respective second outer electrodes 132. In this embodiment, there is depicted an 8-terminal structure in which four outer electrodes are formed on each of the first and second side faces. However, the number of terminals is not limited to the description, and six, ten or more terminals may be employed.

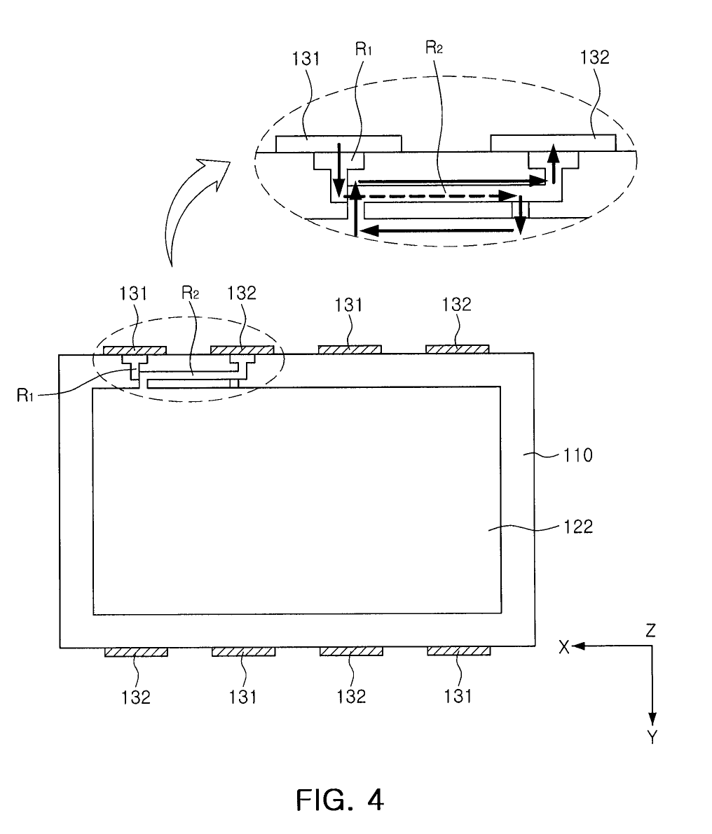

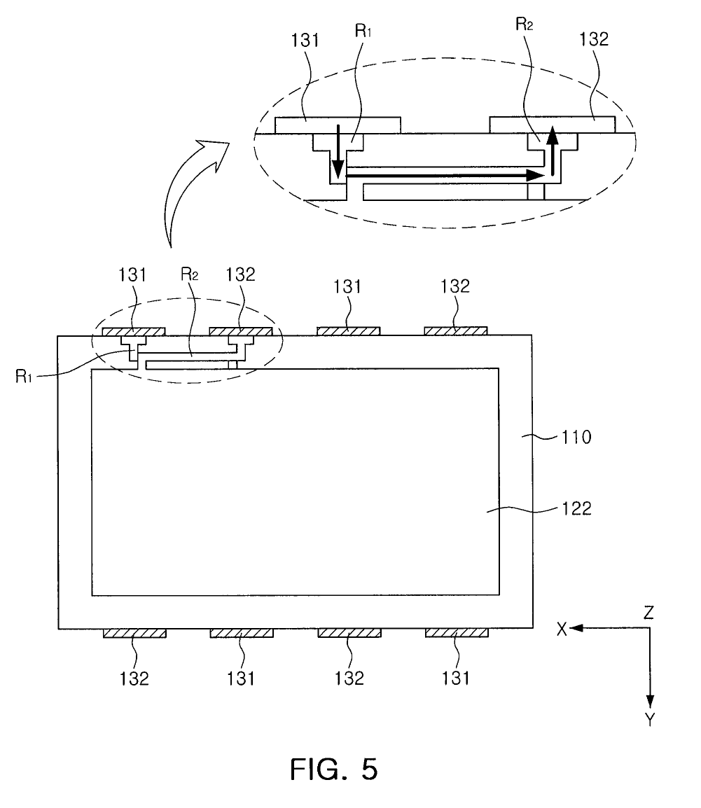

Referring to FIGS. 2 and 3, a plurality of inner electrodes 121 and 122 (hereinafter, referred to as ‘first and second inner electrodes’ respectively) are disposed and are separated by dielectric layers. The first and second inner electrodes 121 and 122 are electrically connected to outer electrodes of like polarity, that is, the first and second outer electrodes 131 and 132, respectively. To this end, the first inner electrode 121 may include an electrode plate forming capacitance, and a lead R1 corresponding to an extrusion electrode extending from the electrode plate. Likewise, the second inner electrode 121 may also include an electrode plate forming capacitance, and a lead R2 corresponding to an extrusion electrode extending from the associated electrode plate. In this embodiment, the respective leads R1 and R2 of the first and second inner electrodes 121 and 122 are each bent at least once. Notably, as shown in FIGS. 4 and 5, the leads R1 and R2 of opposite polarity overlap each other in part when viewed from above or below along a direction in which the inner electrodes are stacked (hereinafter, also referred to as ‘stacked direction ’).

Typically, the use of a multi-terminal structure for the purpose of lowering ESL may lead to a decrease in ESR, which may undermine the stability of a power supply circuit. In this regard, the leads R1 and R2 of the first and second inner electrodes 121 and 122 are bent so that they can have greater lengths and thus increase ESR. In this case, adjusting the lengths and widths (W) of the leads R1 and R2 enables ESR to be controlled to a desired level. For example, since the leads R1 and R2 with smaller widths W are more advantageous in terms of increasing ESR, the widths W of the leads R1 and R2 range from approximately 20 μm to 60 μm which is an allowable range for stable implementation in screen printing. However, although not a requirement in this embodiment, the leads R1 and R2 may each have a connection portion C, for example, which is approximately 100 μm wide, beyond the above range, for stable connection with a corresponding one of the outer electrodes 131 and 132. The use of this connection portion C may further lower ESL.

The bent shape of the leads R1 and R2 may be implemented variously, provided that the shape allows for an increase in the length of the leads R1 and R2. For example, as shown in FIG. 2, each of the leads R1 and R2 may be bent twice so as to have a portion parallel to one side of the associated electrode plate typically having a quadrangular shape. Although not illustrated, the leads R1 and R2 may have an S-shape or an inclined shape with respect to one side of the associated electrode plate.

Typically, an increase in the length of the leads R1 and R2 for the purpose of increasing ESR may result in an increase in ESL, which may deteriorate decoupling performance at high frequencies. To minimize this increase in ESL, as described above, the leads R1 and R2 of the first and second inner electrodes 121 and 121 may overlap each other in part when viewed along the stacked direction. That is, the leads R1 and R2 of the first and second inner electrodes 121 and 122 may each have a portion overlapping a lead of an adjacent inner electrode of opposite polarity when viewed in the stacked direction. This overlap of the leads R1 and R2 in the stacked direction may shorten a current path at high frequencies, and this will be described in detail with reference to FIGS. 4 and 5.

FIGS. 4 and 5 schematically illustrate current paths when the multilayer chip capacitor of FIG. 1 operates with a low frequency current and a high frequency current, respectively. In this case, the description is made assuming that the first outer electrode 131 has positive (+) polarity and the second outer electrode 132 has negative (−) polarity. First, referring to FIG. 4, when a frequency is relatively low, current injected from the first outer electrode 131 flows to the second outer electrode 132 via the lead R1 and the electrode plate of the first inner electrode 121, and the lead R2 of the second inner electrode 122. In contrast, referring to FIG. 5, current having a relatively high frequency may flow from the lead R1 of the first inner electrode 121 to the lead R2 of the second inner electrode 122 through the overlap portion. This reduces the current path, thereby maintaining ESL at a low level even with high frequencies where ESL mainly affects impedance.

According to this embodiment, the lead R1 of the first inner electrode 121 may extend to the first outer electrode 131 from a location of the electrode plate corresponding to the second outer electrode 132 or a location thereof spaced further apart from the first inner electrode 121 than the location corresponding to the electrode plate. Also, the lead R2 of the second inner electrode 122 may extend to the second outer electrode 132 from a location of the electrode plate corresponding to the first outer electrode 131 or a location thereof spaced further apart from the second inner electrode 122. In this way, the structure where the leads R1 and R2 of opposite polarity are each bent to overlap a lead of opposite polarity can be easily implemented.

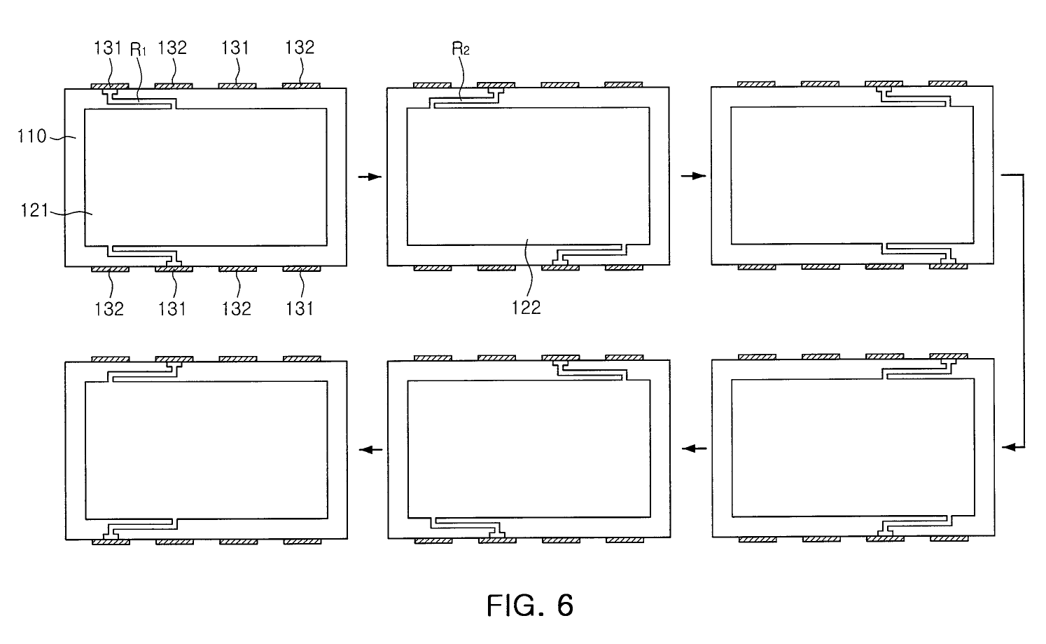

A single lead is illustrated in FIGS. 2 and 3 as being provided for each inner electrode. However, the number and locations of leads may be varied variously. FIGS. 6 through 8 are plan views schematically showing the configurations of inner electrodes applicable to the multilayer chip capacitor depicted in FIG. 1. First, as shown in FIG. 6, the first inner electrode 121 includes two leads R1, and the second inner electrode 122 also includes two leads R2. In detail, one of the two leads in each of the first and second inner electrodes 121 and 122 is extruded to the first side face of the capacitor body 110, and the other lead is extruded to the opposite second side face of the capacitor body 110. As described above, the leads R1 and R2 are bent to thereby increase ESR, and have an overlap structure in the stacked direction to thereby reduce ESL at high frequencies.

The first and second outer electrodes 131 and 132, respectively connected to the leads R1 and R2 of the first and second inner electrodes 121 and 122 being adjacent to each other in the stacked direction, are disposed adjacent to each other so that the magnetic flux generated by a high frequency current is canceled to thereby reduce ESL. Furthermore, In this case, the leads R1 and R2 of the first and second inner electrodes 121 and 122 may be arranged in sequence from one edge to the other edge of the capacitor body 110 and then back from the other edge to the one edge, sequentially in an upward direction of the stacked direction (refer to arrows in FIG. 6). That is, the leads R1 and R2 may be formed in a zigzag arrangement. Three pairs of first and second inner electrodes 121 and 122, a total of six inner electrodes, may be configured as a single block, and this type of block may be repetitively stacked. That is, referring to FIG. 6, the one edge corresponds to the first outer electrode 131 disposed on the very left side, and the other edge corresponds to the second outer electrode 132 disposed on the very right side.

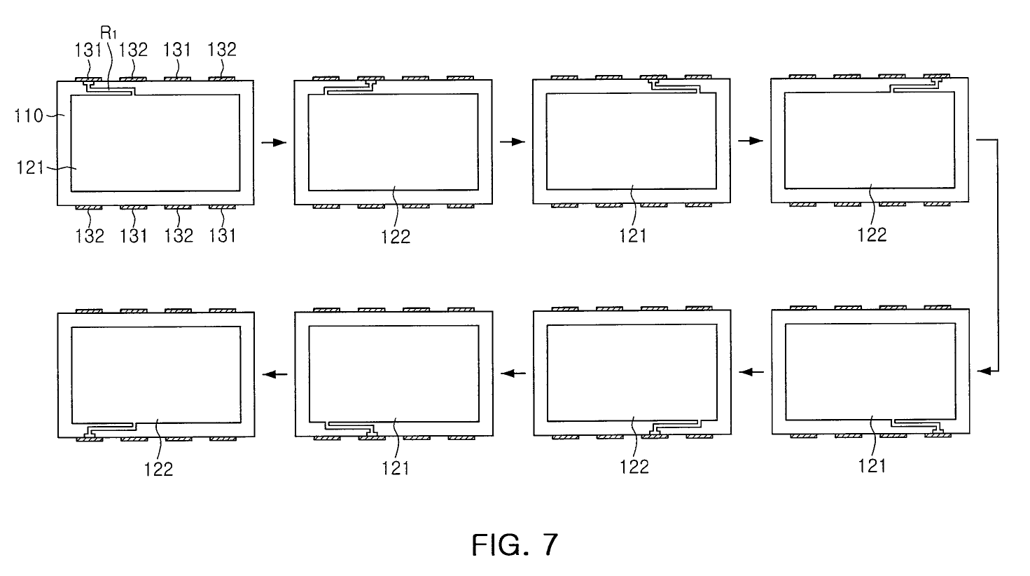

In contrast, as shown in FIG. 7, the first inner electrode 121 may include a single lead R1, and the second inner electrode 122 may also include a single lead R2. In this case, as in the example of FIG. 6, the first and second outer electrodes 131 and 132, respectively connected to the leads R1 and R2 of the first and second inner electrodes 121 and 122 adjacent to each other in the stacked direction, are disposed adjacent to each other. In this case, the leads R1 and R2 of the first and second inner electrodes 121 and 122 may be arranged in sequence from one edge to the other edge of the capacitor body 110 and then back from the other edge to the one edge. In this example of FIG. 7, four pairs of first and second inner electrodes 121 and 122, a total of eight inner electrodes, are configured as one block, and this type of block may be repetitively stacked. In this embodiment, ESR can be increased by limiting the number of leads for each inner electrode to one.

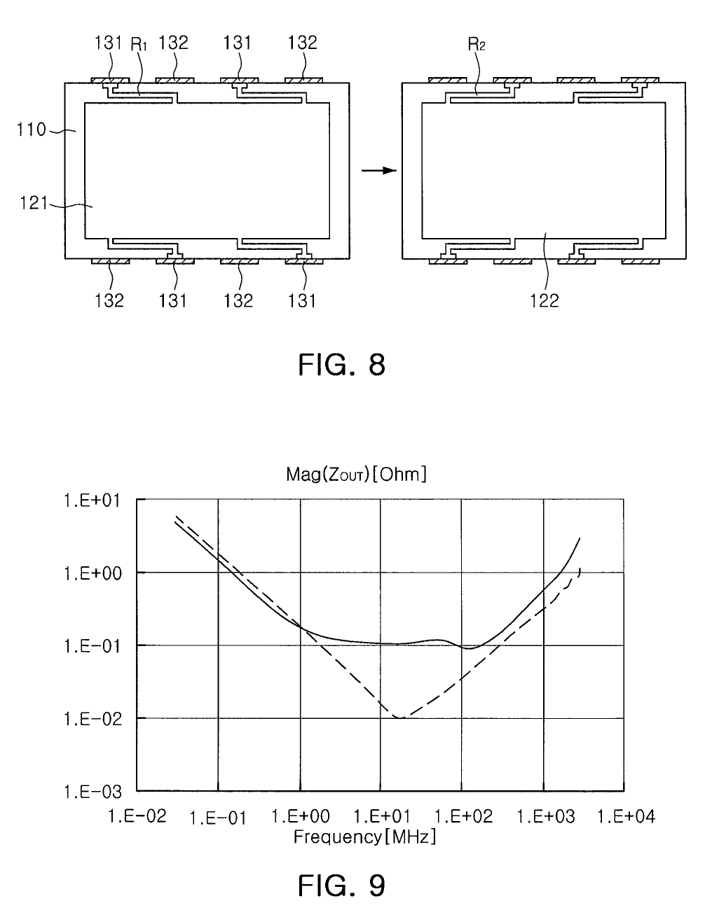

As shown in FIG. 8, the first inner electrode 121 may include four leads R1, and the second inner electrode 122 may also include four leads R2. Two out of the four leads of each of the first and second inner electrodes 121 and 122 are extruded to the first side face, and the other two are extruded to the opposite second side face. In this case, the first and second outer electrodes 131 and 132, respectively connected to the leads R1 and R2 of the first and second inner electrodes 121 and 122 adjacent to each other in the stacked direction, are disposed adjacent to each other. Accordingly, magnetic flux generated by high frequency current is canceled to thereby lower ESL.

FIG. 9 is an impedance graph for performance comparison between multilayer chip capacitors according to the present invention and the related art. In FIG. 9, a solid curve represents a multilayer chip capacitor having a structure depicted in FIG. 6, and a dotted curve represents a multilayer chip capacitor employing, in the manner of the structure of FIG. 6, a related art lead structure where no leads are bent or overlap one another. Referring to FIG. 9, the structure of FIG. 6 attains ESR of approximately 110 mΩ, which is significantly greater than the ESR of approximately 11 mΩ according to the related art, and ESL in the structure of FIG. 6 increases to 81 pH from 59 pH, which is, however, a relatively small change as compared with ESR. As described above, when a multilayer chip capacitor according to this embodiment is used, ESL may increase significantly while ESL is maintained at a relatively low level.

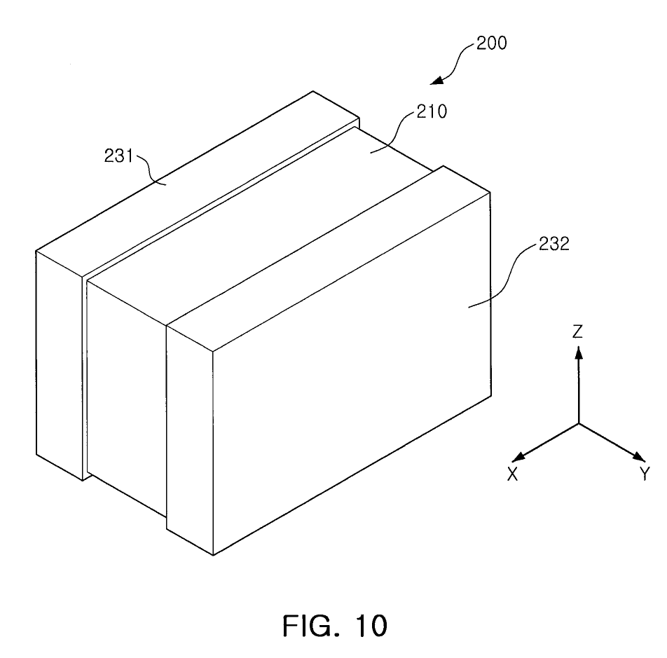

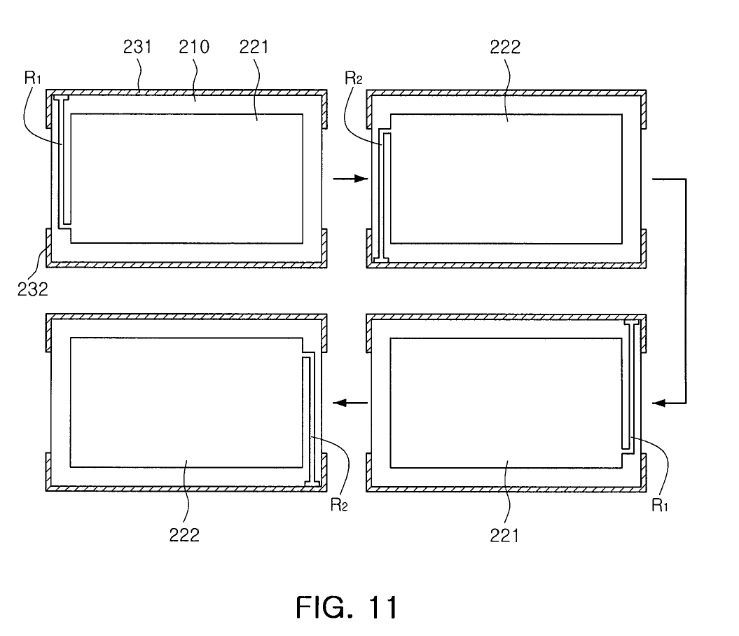

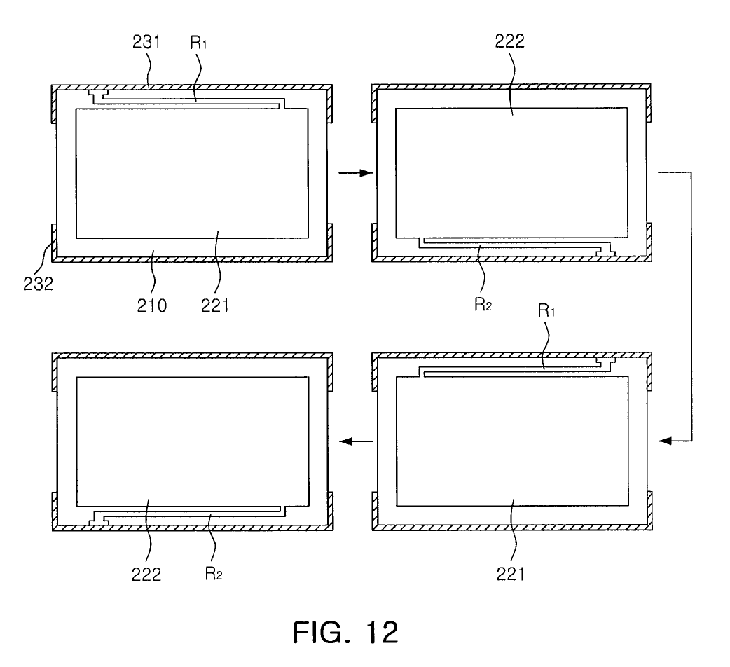

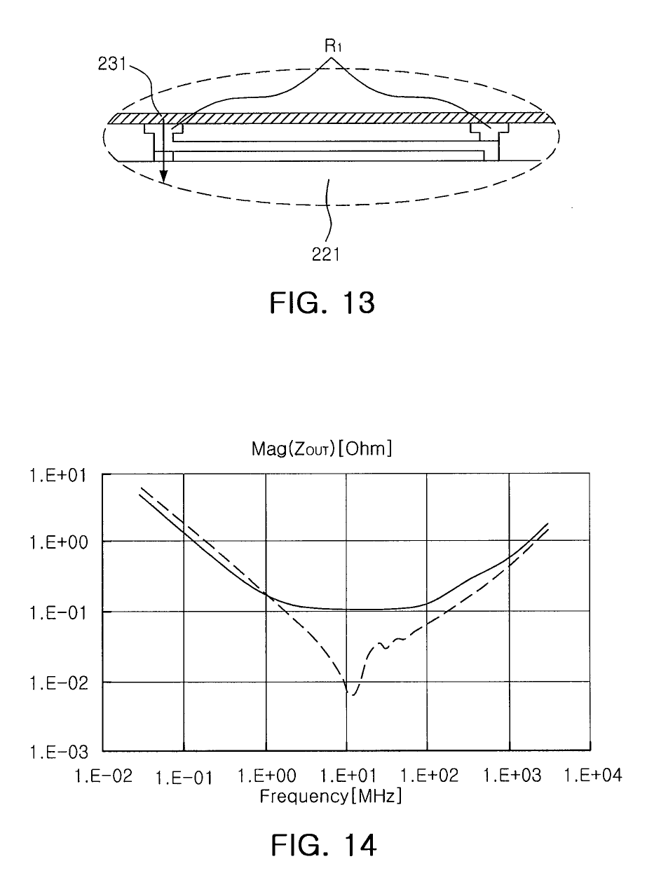

FIG. 10 is a schematic perspective view illustrating a multilayer chip capacitor according to another exemplary embodiment of the present invention. FIGS. 11 and 12 are schematic plan views for explaining the configuration of inner electrodes provided in the multilayer chip capacitor of FIG. 10. FIG. 13 is a view schematically showing a current path when the multilayer chip capacitor of FIG. 12 operates with a high frequency current. Referring to FIG. 10, a multilayer chip capacitor 200, according to this embodiment, has a 2-terminal structure including a capacitor body 210 and first and second outer electrodes 231 and 232 formed on side faces of the capacitor body 210. The capacitor body 210 may be formed by stacking a plurality of dielectric layers, and may have a rectangular parallelepiped shape or another similar shape. The first and second outer electrodes 231 and 232 having opposite polarity may be formed on a first side face of the capacitor body 210 and a second side face opposite to the first side face, respectively. In this embodiment, the first and second outer electrodes 231 and 232 are disposed on longer side faces of the capacitor body 210; however, they may be disposed on shorter side faces of the capacitor body 210. Here, the longer side face refers to aside face having a longer side in the capacitor body 210 having a rectangular parallelepiped shape, and the shorter side face refers to a side face perpendicular to the longer side face.

An inner electrode structure will now be described with reference to FIG. 11. The first inner electrode 221 includes an electrode plate and a lead R1, and the second inner electrode 222 also includes an electrode plate and a lead R2. As in the previous embodiment, the leads R1 and R2 of the first and second inner electrodes are bent and have overlapped portions in a stacked direction. In this case, the leads R1 and R2 may respectively extend from the sides of the associated rectangular electrode plates, which are perpendicular to the first side face and the second side face, when viewed along the stacked direction.

As shown in FIG. 12, the leads R1 and R2 of the first and second inner electrodes 221 and 222 may respectively extend from the sides of the associated rectangular electrode plates opposing the first and second side faces when viewed along the stacked direction. In this case, unlike the above-described example, the lead R1 overlaps another lead R1 of like polarity, and the lead R2 overlaps another lead R2 of like polarity. That is, the lead R1 of the first inner electrode 221 overlaps a lead R1 of another first inner electrode 221, interposing the second inner electrode 222 therebetween. When leads of like polarity overlap each other, high-frequency current may flow from the lead R1 of the first inner electrode 221 to the lead R1 of another adjacent first inner electrode 221 without passing through an overlap area, thereby reducing a current path and thus achieving a reduction in ESL. In this case, a portion of the lead R1 of the first inner electrode 221 provided as a path for high frequency current, that is, a connection portion of the lead R1 disposed perpendicularly to the first side face connected to the first outer electrode 231, may have a greater width than a portion of the lead R1 parallel to the first and second side faces. In the same way, a portion of the lead R2 of the second inner electrode 222 provided as a path for high frequency current, that is, a connection portion of the lead R2 disposed perpendicularly to the second side face and connected to the second outer electrode 232, may have a greater width than a portion of the lead R2 parallel to the first and second side faces.

FIG. 14 is an impedance graph for performance comparison between multilayer chip capacitors according to the present invention and the related art. In FIG. 14, a solid curve represents a multilayer chip capacitor having a structure depicted in FIG. 12, and a dotted curve represents a multilayer chip capacitor including an electrode plate directly contacting an outer electrode without the leads in the structure as depicted in FIG. 12. Referring to FIG. 14, when the structure of FIG. 12 is used, ESR is approximately 109 mΩ, which is a significant increase as compared to the ESR of approximately 6.3 mΩ according to the related art, and ESL increases slightly from 108 pH to 110 pH, which is a relatively small change as compared to the ESR.

As set forth above, according to exemplary embodiments of the invention, a multilayer chip capacitor, capable of ensuring sufficiently high ESR while implementing ESL at a low level is provided. When this multilayer chip capacitor is used as a decoupling capacitor for a power distribution network for MPU, DC voltage noise can be effectively suppressed at high frequencies.

While the present invention has been shown and described in connection with the exemplary embodiments, it will be apparent to those skilled in the art that modifications and variations can be made without departing from the spirit and scope of the invention as defined by the appended claims.

What is claimed is:

1. A multilayer chip capacitor comprising:
a capacitor body including a plurality of dielectric layers that are stacked;
first and second outer electrodes of opposite polarity, disposed on an outer face of the capacitor body;
first and second inner electrodes opposing each other inside the capacitor body to interpose the dielectric layer therebetween, the first inner electrode comprising an electrode plate forming capacitance and a lead extending from the electrode plate and connected to the first outer electrode, and the second inner electrode comprising an electrode plate forming capacitance and a lead extending from the electrode plate and connected to the second outer electrode,
wherein the leads are bent at least once and each have an overlap portion overlapping a lead of an adjacent inner electrode of opposite or like polarity when viewed along a stacked direction in which the plurality of dielectric layers are stacked.

2. The multilayer chip capacitor of claim 1, wherein the electrode plates have a rectangular shape when viewed in the stacked direction, and the leads each have a portion parallel to one side of the rectangular shape.

3. The multilayer chip capacitor of claim 2, wherein the overlap portion is included in the portion parallel to one side of the rectangular shape.

4. The multilayer chip capacitor of claim 1, wherein the leads have a width ranging from 20 μm to 60 μm.

5. The multilayer chip capacitor of claim 1, further comprising a connection portion disposed at a connection area between each of the leads and a corresponding one of the first and second outer electrodes, the connection portion having a wider width than the leads.

6. The multilayer chip capacitor of claim 1, wherein the first and second outer electrodes comprise a plurality of first and second outer electrodes alternately disposed on one and opposite faces of the capacitor body.

7. The multilayer chip capacitor of claim 6, wherein the first and second outer electrodes comprise four first and second outer electrodes disposed on each of one and opposite faces of the capacitor body.

8. The multilayer chip capacitor of claim 6, wherein the second outer electrodes oppose the respective first outer electrodes.

9. The multilayer chip capacitor of claim 6, wherein the first and second outer electrodes, respectively connected to the leads of the first and second inner electrodes disposed adjacent to each other in the stacked direction, are disposed adjacent to each other.

10. The multilayer chip capacitor of claim 9, wherein the first and second inner electrodes each comprise a lead respectively extending to each of one and opposite faces of the capacitor body.

11. The multilayer chip capacitor of claim 10, wherein the leads of the first and second inner electrodes are arranged in sequence from one edge to the other edge of the capacitor body and then back from the other edge to the one edge, sequentially in an upward direction of the stacked direction.

12. The multilayer chip capacitor of claim 11, wherein the first and second inner electrodes are provided in three pairs so that six inner electrodes constitute a block, and the block is repetitively stacked.

13. The multilayer chip capacitor of claim 9, wherein the first and second inner electrodes each comprise one lead extending to one face of the capacitor body.

14. The multilayer chip capacitor of claim 13, wherein the leads of the first and second inner electrodes are arranged in sequence from one edge to the other edge of the capacitor body and then back from the other edge to the one edge, sequentially in an upward direction of the stacked direction.

15. The multilayer chip capacitor of claim 14, wherein the first and second inner electrodes are provided in four pairs so that eight inner electrodes constitute a block, and the block is repetitively stacked.

16. The multilayer chip capacitor of claim 9, wherein the first and second inner electrodes each include two leads extending to each of one and opposite faces of the capacitor body.

17. The multilayer chip capacitor of claim 1, wherein the capacitor body has a rectangular parallelepiped shape, and
the first and second outer electrodes are formed on a first side face of the capacitor body and a second side face thereof opposite to the first side face, respectively.

18. The multilayer chip capacitor of claim 17, wherein the electrode plates of the first and second inner electrodes each have a rectangular shape when viewed in the stacked direction,
the lead of the first inner electrode extends from a side of the electrode plates perpendicular to the first and second first side faces and
the lead of the second inner electrode extends from a side of the electrode plate perpendicular to the first and second side faces.

19. The multilayer chip capacitor of claim 17, wherein the electrode plates of the first and second inner electrodes each have a rectangular shape when viewed in the stacked direction,
the lead of the first inner electrode extends from a side of the electrode plate opposing the first side face, and
the lead of the second inner electrode extends from a side of the electrode plate opposing the second side face.

20. The multilayer chip capacitor of claim 19, wherein the first and second inner electrodes each have a portion overlapping a lead of an inner electrode of like polarity, which is disposed adjacent thereto when viewed in the stacked direction.

21. The multilayer chip capacitor of claim 20, wherein a portion of the lead of the first inner electrode, connected to the first outer electrode perpendicularly to the first side face, has a wider width than a portion of the lead of the first inner electrode being parallel to the first side face, and
a portion of the lead of the second inner electrode, connected to the second outer electrode perpendicularly to the second side face, has a wider width than a portion of the lead of the second inner electrode being parallel to the second side face.

22. A multilayer chip capacitor comprising:
a capacitor body including a plurality of dielectric layers that are stacked;
first and second outer electrodes of opposite polarity, disposed on an outer face of the capacitor body; and
first and second inner electrodes opposing each other inside the capacitor body to interpose the dielectric layer therebetween, the first inner electrode including an electrode plate forming capacitance and a lead extending from the electrode plate and connected to the first outer electrode, and the second inner electrode including an electrode plate forming capacitance and a lead extending from the electrode plate and connected to the second outer electrode,
wherein the leads are bent at least once,
the lead of the first inner electrode is connected to the first outer electrode and extends from a location of the electrode plate corresponding to the second outer electrode or a location thereof spaced further apart from the first inner electrode than the location corresponding to the second outer electrode, and
the lead of the second inner electrode is connected to the second outer electrode and extends from a location of the electrode plate corresponding to the first outer electrode or a location thereof spaced further apart from the second inner electrode than the location corresponding to the first outer electrode.
